(19) United States
(12) Patent Application Publication
(10) Pub. No.: US 2025/0335899 A1
(43) Pub. Date: Oct. 30, 2025

(54) SHORT RANGE SIGNAL TECHNOLOGY FOR INTER-DEVICE COMMUNICATION

(71) Applicant: Truist Bank, Charlotte, NC (US)

(72) Inventors: Hayden Rebecca Thomas, Charlotte, NC (US); Jamie Nathaniel Franklin, Charlotte, NC (US)

(73) Assignee: Truist Bank, Charlotte, NC (US)

(21) Appl. No.: 18/646,122

(22) Filed: Apr. 25, 2024

(51) Int. Cl. G06Q 20/32; G06Q 20/10

(52) U.S. Cl. CPC G06Q 20/3278; G06Q 20/1085

(57) ABSTRACT

A method and system for cardless cash withdrawal from an automated teller machine (ATM) using a mobile device with near-field communication (NFC) connectivity. A user places a mobile device proximal the ATM where the device is within range and NFC connectivity is established. The NFC channel ensures that the user is physically located at the ATM, and also enables data exchange from a digital banking systems application on the device to the ATM. Data communicated to the ATM from the mobile device includes the identity of a client and an account containing funds for the withdrawal. The digital banking app on the mobile device may provide other data to the ATM—such as the withdrawal amount. An authentication step, including a biometric scan or entry of a personal identification number, further secures the withdrawal transaction, where the authentication may be performed on the mobile device or on the ATM.

### FIELD

The present disclosure relates generally to the field of digital banking data systems, and more particularly to a system and method for enabling cardless cash withdrawals from automated teller machines (ATMs), including using a mobile device running a bank's digital banking application and communicating with an ATM via near-field communication (NFC) to authorize the withdrawal transaction.

### BACKGROUND

Automated teller machines (ATMs) have been in use for many years, allowing bank clients to withdraw cash from a bank account at ATMs at bank branch offices and many other locations, and at all hours of the day and night. The traditional method of using an ATM involves inserting an ATM card or debit card, connected with the client's bank account, into the ATM machine and entering a PIN. Credit cards, including those issued by banks other than the client's own bank, may also be used to obtain cash from an ATM, usually incurring a transaction fee. The act of physically producing the card, along with entering the PIN, serves as authentication of the identity of the person seeking the cash, and authorization to access the bank account.

In recent years, many more retailers have started accepting credit and debit card payments, even for small purchases such as fast food and drinks. As a result, many consumers have gone “cashless”—carrying no cash and instead using credit or debit cards for virtually all purchases. In addition, some consumers have gone even further—using “pay by phone” apps to pay for purchases electronically, without the need to even produce a credit or debit card at the point of sale. For these “cardless” consumers, there is a real desire to not carry credit cards or debit cards on their person at all. However, until now, a card has been needed at ATM machines on those occasions when a cash withdrawal is needed. Furthermore, even for people who carry credit and debit cards on their person, the mobile phone is often the most convenient and preferred means of performing a purchase or other transaction.

In light of the circumstances described above, there is a need for an improved method of withdrawing cash from an ATM which does not require the use of an ATM card.

### BRIEF SUMMARY

The present disclosure describes a method and system for cardless cash withdrawal from an automated teller machine (ATM) using a mobile device with near-field communication (NFC) connectivity. A user places a mobile device proximal a designated location on an ATM where the device is within range and NFC connectivity to the ATM is established. The NFC channel ensures that the user is physically located at the ATM, and also enables data exchange from a digital banking systems application on the device to the ATM. Data communicated to the ATM from the mobile device includes the identity of a client and an account of the client containing sufficient funds for the withdrawal. The digital banking app on the mobile device may be used to provide other data to the ATM—such as the cash withdrawal amount. An authentication step, including a biometric scan or entry of a personal identification number, serves to further secure the cash withdrawal transaction, where the authentication step may be performed either on the mobile device or on the ATM.

The features, functions, and advantages that have been discussed may be achieved independently in various embodiments of the present disclosure or may be combined in yet other embodiments, further details of which can be seen with reference to the following description and drawings, along with the appended claims.

### BRIEF DESCRIPTION OF THE DRAWINGS

FIG. 1 illustrates an enterprise system, and environment thereof, including a centralized server system, distributed computers and mobile devices, and communication therebetween, according to at least one embodiment of the present disclosure;

FIG. 2 is a simplified illustration of the enterprise system of FIG. 1, showing the elements most directly involved in the NFC-enabled cash transfer app as embodied in the techniques of the present disclosure;

FIG. 3 is an illustration of a mobile device in the general vicinity of an ATM which will be used for a cardless cash withdrawal, according to an embodiment of the present disclosure;

FIG. 4 is a mock-up illustration of a display screen on the mobile device of FIG. 3, depicting an optional first step in making a cardless cash withdrawal from the ATM of FIG. 3, according to an embodiment of the present disclosure;

FIG. 5 is an illustration of the mobile device of FIGS. 3-4 brought into close physical proximity with and establishing near-field communication with the ATM of FIG. 3 for the purpose of cardless cash withdrawal, according to an embodiment of the present disclosure;

FIG. 6 is a mock-up illustration of a display screen on the mobile device of previous figures, depicting steps which may be taken by the user in performing a cardless cash withdrawal from the ATM of FIG. 5, according to an embodiment of the present disclosure;

FIG. 7 is a mock-up illustration of a display screen on the mobile device of previous figures, depicting steps which may be taken by the user in completing a cardless cash withdrawal from the ATM of FIG. 5, according to an embodiment of the present disclosure;

FIG. 8 is a mock-up illustration of a display screen on the mobile device of previous figures, depicting steps which may be taken by the user in completing a cardless cash withdrawal from the ATM of FIG. 5, according to another embodiment of the present disclosure; and

FIG. 9 is a flowchart diagram of a method for making a cardless cash withdrawal from an ATM using a mobile device communicating with the ATM via near-field communication (NFC), according to an embodiment of the present disclosure.

### DETAILED DESCRIPTION OF EMBODIMENTS

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

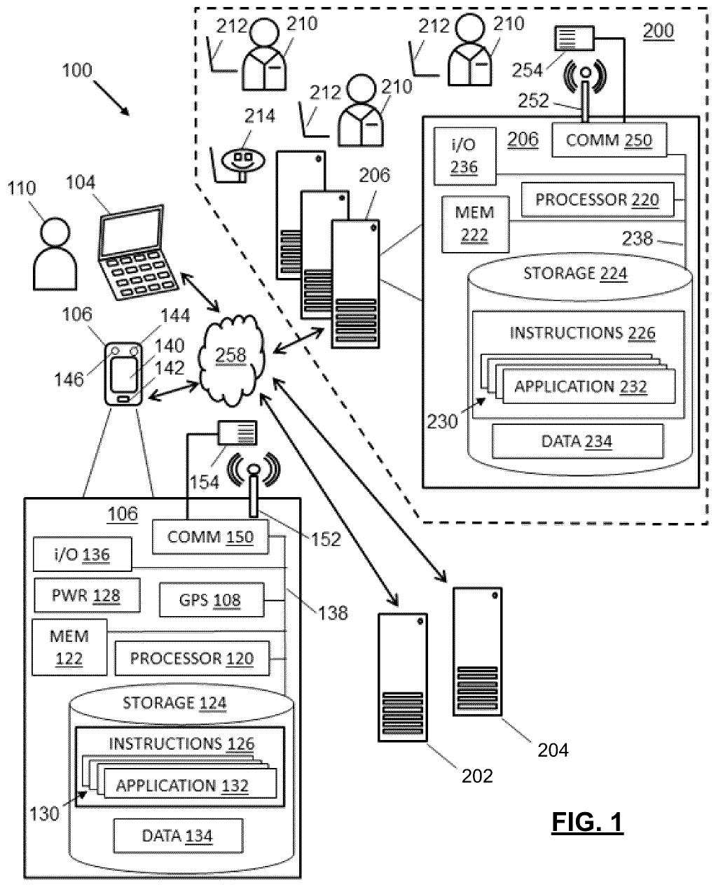

FIG. 1 illustrates a system 100 and environment thereof, including centralized and distributed computing devices, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11 a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matters of these descriptions pertain.

A machine learning program may be configured to implement stored processing, such as decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, in order to implement the stored processes and/or optimize the machine learning logic training and interface.

One type of algorithm suitable for use in machine learning modules as described herein is an artificial neural network or neural network, taking inspiration from biological neural networks. An artificial neural network can, in a sense, learn to perform tasks by processing examples, without being programmed with any task-specific rules. A neural network generally includes connected units, neurons, or nodes (e.g., connected by synapses) and may allow for the machine learning program to improve performance. A neural network may define a network of functions, which have a graphical relationship. As an example, a feedforward network may be utilized, e.g., an acyclic graph with nodes arranged in layers.

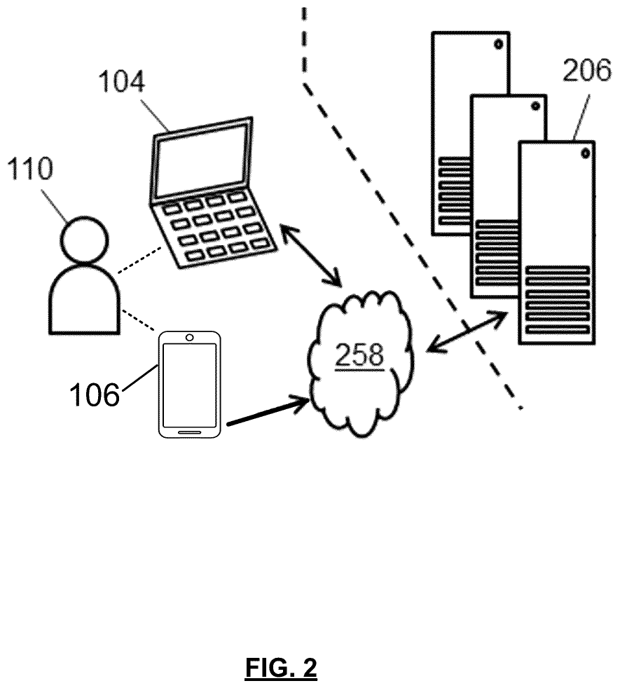

FIG. 2 is a simplified illustration of the enterprise architecture depicted in FIG. 1, showing the elements most directly involved in using online/digital banking systems. The user 110 (e.g., a client) uses either the computing device 104 or the mobile device 106 to access a digital banking system, where the computing device 104 would run a web browser application in which the digital banking system is displayed, and the mobile device 106 would run a mobile application (“app”) specifically designed as the digital banking system. The computing device 104 and/or the mobile device 106 communicate with the computing system (back-end servers) 206 via the network (“the cloud”) 258.

Banking customers have at least one account, and often more than one account, with a bank business. These accounts may include savings accounts, checking accounts, investment accounts, credit cards, loans, mortgages, etc. Online/digital banking systems are now widely used because they enable clients to conveniently perform most banking functions electronically—including opening accounts, transferring money between accounts, paying bills, viewing transaction details, etc. The use of online/digital banking systems as related to the techniques of the present disclosure will be illustrated in later figures and described in the discussion accompanying those figures.

Having described an enterprise computing environment as might be used by a banking business, and general characteristics of systems including online and digital banking systems which may be employed in the enterprise computing environment, attention is now turned to the specific topic of the present disclosure—a method and system for performing cardless cash withdrawals from automated teller machines (ATMs) which takes advantage of mobile device near-field communication capability.

As has been discussed above, bank businesses operate many different types of computer systems and databases—including online and digital banking systems, and the back-office systems which handle all of the bank's client and account data. Many clients have the bank's digital banking system running as a mobile application (app), such as on a smartphone. People who have apps such as a digital banking systems app running on their mobile device typically have their device (e.g., smartphone) with them at virtually all times and places.

The techniques of the present disclosure describe a method and system which enable a cash withdrawal from an ATM without the need for the client to use an ATM card (or debit/credit card). This alleviates the need for the client to carry the ATM card on his/her person or, at a minimum, alleviates the need for the client to take the card out of a wallet or purse to be inserted into the ATM. The disclosed techniques recognize that most smartphone users always have the device on their person. The techniques also take advantage of the availability on most modern mobile devices, and the unique short-range communication properties of, near-field communication.

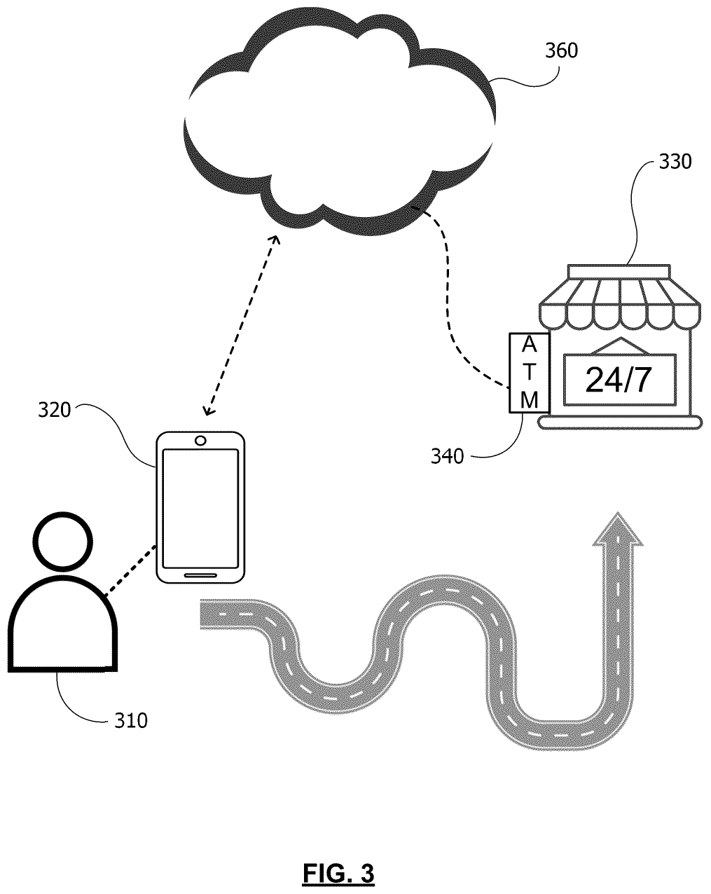

FIG. 3 is an illustration of a mobile device in the general vicinity of an ATM which will be used for a cardless cash withdrawal, according to an embodiment of the present disclosure. A user 310 has a mobile device 320. In the example depicted in FIG. 3, a nearby convenience store 330 has an ATM 340. The ATM 340 is presumed to be the nearest ATM to the user 310. In this example, discussion of which continues through the next several figures, the user 310 is a bank client with a digital banking systems app running on the mobile device 320. The user 310 wishes to find a nearby ATM of the bank at which the user/client has an account. The user 310 also wishes to prepare a cash withdrawal in advance, so that upon arrival at the ATM 340 the actual dispensing of the cash is quick and convenient, and does not require the user 310 to produce an ATM card. The cash withdrawal transaction is ultimately enabled by near-field communication between the mobile device 320 and the ATM 340.

Near-field communication (NFC) is a set of communication protocols that enables communication between two electronic devices over a very short distance. NFC offers a low-speed connection through a simple setup that can be used for its own communication purposes or for the bootstrapping of other wireless communication technologies. NFC is based on inductive coupling between two electromagnetic coils present on NFC-enabled devices such as smartphones. NFC devices communicating in one or both directions use a frequency of 13.56 megahertz (MHz). The effective range of NFC for inter-device connectivity is on the order of a few centimeters (cm)—such as less than five cm. Most modern mobile devices (e.g., smartphones) include NFC capability. Many other types of computing devices and machines may also be equipped with NFC capability—including retail point-of-sale systems, and ATMs.

Other communication technologies and combinations thereof may be employed in the techniques of the present disclosure. For example, NFC may be used to establish the close physical proximity of the mobile device to the ATM and initiate device-to-device communication, and thereafter a communication technology having a higher bandwidth (such as Bluetooth or peer-to-peer WiFi) may be used for ongoing device-to-device communication and transaction execution, potentially dependent upon the close physical proximity of the devices being maintained.

The mobile device 320 and the ATM 340 are also understood to be in communication with any and all needed server-based and internet-based systems, as represented by a cloud 360. Via the cloud 360, the mobile apps (such as the digital banking app) running on the mobile device 320 communicate with the servers necessary for information exchange and transaction execution, as discussed earlier with respect to FIG. 1 and as understood by those skilled in the art. Likewise for the software running on the ATM 340.

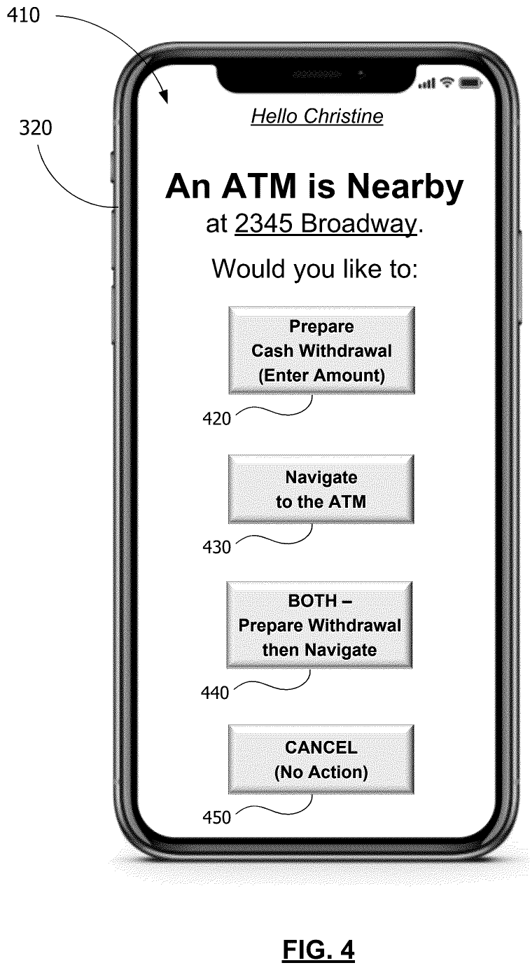

Features of the presently-disclosed method and system may be used beginning in the situation shown in FIG. 3, where the user 310 and the mobile device 320 are still some distance away from the ATM 340 (e.g., a few blocks away, or a mile away). The mobile device 320 and the ATM 340 of FIG. 3 are used in the implementation examples depicted in FIGS. 4-8.

FIG. 4 is a mock-up illustration of a display screen 410 on the mobile device 320, depicting an optional first step in making a cardless cash withdrawal from the ATM 340, according to an embodiment of the present disclosure. In the scenario of FIG. 4, the user 310 is using the digital banking app on the mobile device 320, while the user 310 is still some distance away from the ATM 340 as illustrated in FIG. 3. The user 310 may wish to get navigation instructions to a nearest or nearby ATM, and may also wish to prepare (i.e., sort of “pre-order”) a cash withdrawal from the nearby ATM.

Near the top of the display screen 410, after the user 310 has asked the digital banking systems app to find a nearby ATM, a message in the app is displayed indicating that an ATM is nearby at a particular address. The user 310 is then offered options for what action to take. The options include preparing a cash withdrawal in advance of arrival at the ATM (using a button 420), getting navigation instructions to the particular ATM (using a button 430), both preparing the withdrawal and navigating (using a button 440), or canceling (taking no action—using a button 450).

Preparing or pre-ordering a cash withdrawal, using the button 420 or 440, is an optional step which the user may take in order to make the actual dispensing of cash at the ATM even faster and easier. One of the benefits of the disclosed technique for cardless cash withdrawal is that certain traditional steps—such as producing an ATM card and inserting the card into the machine—can be skipped, thereby simplifying the process of cash withdrawal. The user's physical interaction with the ATM can be further simplified by using the digital banking system app and the user's mobile device to enter information which is traditionally entered on an ATM screen. This is what preparing or pre-ordering a cash withdrawal enables. When the user clicks the button 420 (or 440), the digital banking app will prompt the user for the amount of cash to be withdrawn (e.g., $100). The digital banking app may also ask the user what mix of bills should be used for the withdrawal (e.g., four $20 bills and two $10 bills). Defining these parameters in advance allows the user to spend less time physically present at the ATM, which is an improvement in both convenience and safety.

The display screen 410 is simply illustrative of any type of app screen, push notification, or other pop-up message which may be displayed on a mobile device. It is to be understood that the design of the display screens (in FIG. 4 and later figures), the use of buttons versus checkboxes versus radio buttons, the options and option wording, and other design features are all variable from one implementation to another based on design preference.

The mobile device 320 is not in NFC contact with the ATM 340 in the scenario of FIGS. 3 and 4. Rather, the mobile device 320 uses location services to identify its own physical location, and known mapping capability to determine distance and directions to the ATM 340. It is also emphasized that the techniques of the present disclosure do not require the use of the features shown on FIG. 4. These features (pre-order of a cash withdrawal, and navigation to an ATM) are provided as an added convenience to users of the digital banking systems app in addition to the core capability which is cardless cash withdrawal using NFC on a mobile device.

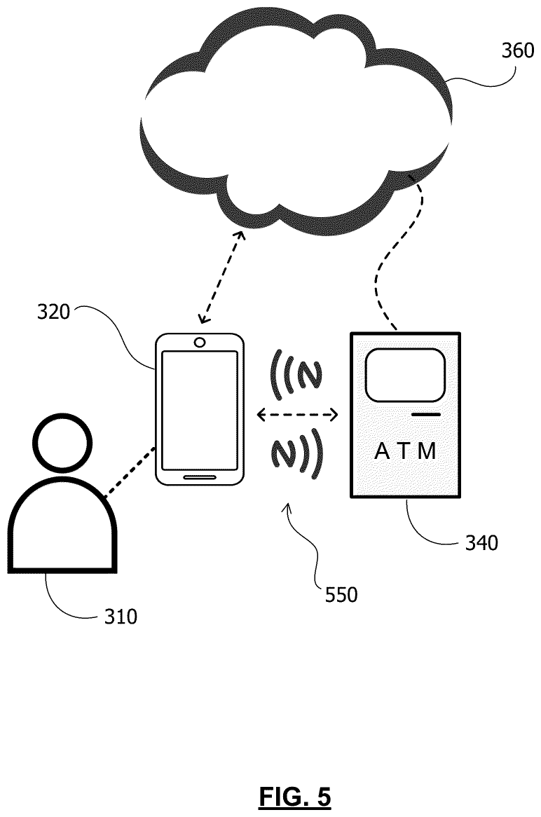

FIG. 5 is an illustration of the mobile device 320 brought into close physical proximity with and establishing near-field communication (NFC) with the ATM 340 for the purpose of cardless cash withdrawal, according to an embodiment of the present disclosure. In the scenario of FIG. 5, the user 310 has arrived at the convenience store 330 (of FIG. 3) and is now standing next to the ATM 340. This is just one example of course—the user could also have driven to a drive-up ATM and be parked adjacent the machine, or some other equivalent situation. The understanding is that the user 310 is physically present at the ATM 340 and will be able to receive cash when dispensed, and that the user 310 is able to place the mobile device 320 at a designated spot on the ATM 340 in order to establish NFC. The ATM 340 of FIG. 5 is equipped with a near-field communication system enabling communication with the mobile device 340 when within range.

When the mobile device 320 is placed in close physical proximity to the ATM 340, they establish NFC communication, as indicated at 550. This would happen when the user 310 purposely brings the mobile device 320 very close to the ATM 340 (within a few cm)—such as by placing the mobile device 320 against a designated location on the ATM 340. Automatic detection and establishment of NFC communication with another device is a known capability of modern mobile devices and NFC systems. Using this detected NFC communication channel to initiate or trigger the secure and convenient dispensing of money from the ATM 340 is the subject of the present disclosure.

In FIG. 5, the mobile device 320 and the ATM 340 are understood to still be in communication with any and all needed server-based and internet-based systems, as represented by the cloud 360 and discussed earlier. Other communication technologies and combinations thereof may be employed in the techniques of the present disclosure. For example, NFC may be used to establish the close physical proximity of the mobile device to the ATM and initiate device-to-device communication, and thereafter a communication technology having a higher bandwidth (such as Bluetooth or peer-to-peer WiFi) may be used for ongoing device-to-device communication and transaction execution, whether the close physical proximity of the devices is maintained continuously or only momentarily.

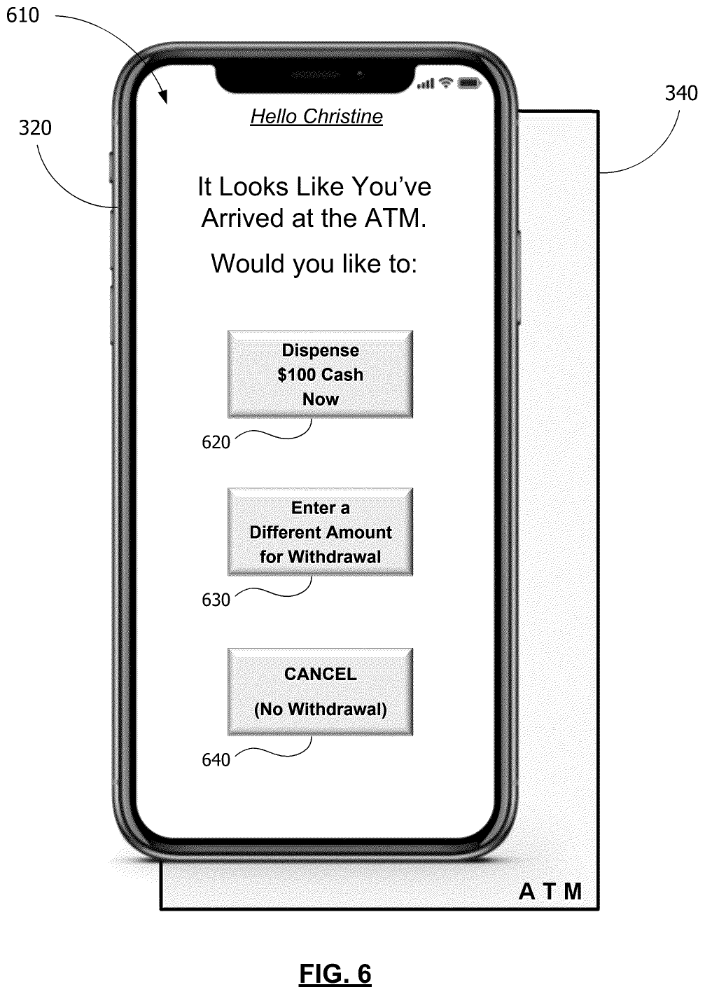

FIG. 6 is a mock-up illustration of a display screen 610 on the mobile device 320, depicting steps which may be taken by the user 310 in performing a cardless cash withdrawal from the ATM 340, according to an embodiment of the present disclosure. In FIG. 6, the mobile device 320 is in the foreground, and the ATM 340 is shown in the background, indicating that the mobile device 320 and the ATM 340 are in the same location. The display screen 610 of FIG. 6 illustrates a next step when the user 310 has arrived at the ATM 340, after the earlier interaction shown on FIG. 4.

At the top of the display screen 610, the digital banking systems app notifies the user 310 that she has arrived at the ATM 340. The display screen 610 could be displayed automatically by the digital banking app upon arrival (as determined from the mobile device's location services and ATM locations which are known to the digital banking app). Alternately, if the mobile device 320 is locked, a pop-up notification or teaser could be displayed on the mobile device 320 upon arrival, where the user 310 could then tap on the teaser or notification and unlock the device and re-enter the digital banking app.

If the user 310 prepared or pre-ordered a cash withdrawal as shown on FIG. 4, then a button 620 allows the user 310 to verify the previously-defined amount to proceed with the cardless cash withdrawal. If the user 310 did not previously define a cash withdrawal amount, or if the user 310 wishes to change the previously-defined amount, then a button 630 may be used to enter a withdrawal amount and proceed. A button 640 allows the user 310 to cancel the withdrawal.

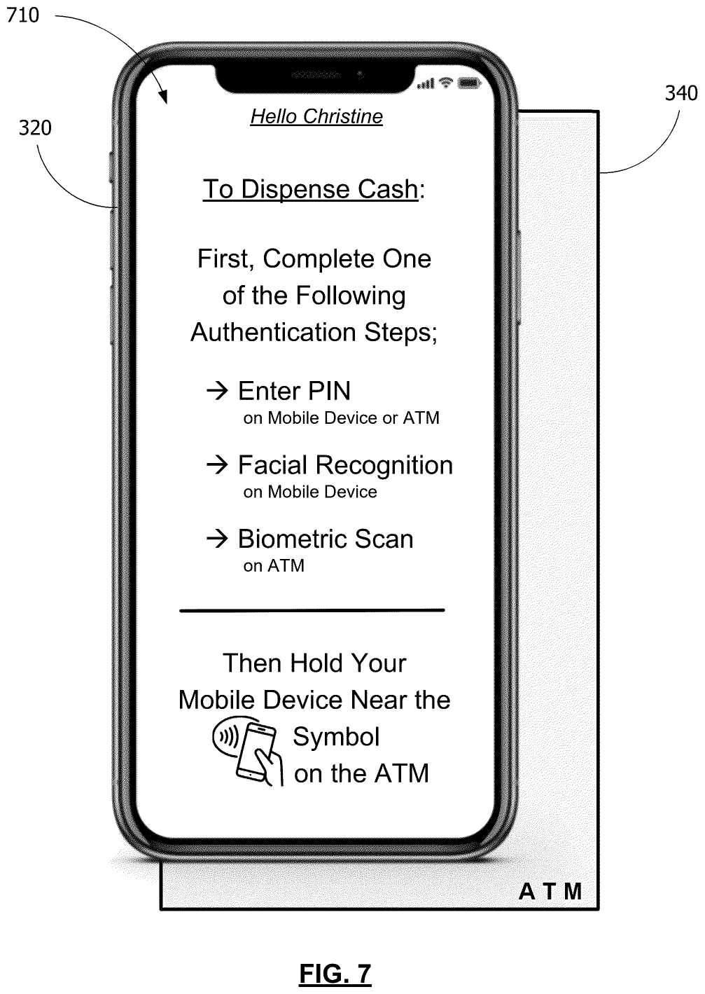

FIG. 7 is a mock-up illustration of a display screen 710 on the mobile device 320, depicting steps which may be taken by the user 310 in completing a cardless cash withdrawal from the ATM 340, according to an embodiment of the present disclosure. In FIG. 7, the mobile device 320 is again in the foreground with the ATM 340 in the background, indicating that the mobile device 320 and the ATM 340 are in the same location. The display screen 710 illustrates the final steps taken to complete the cardless cash withdrawal from the ATM 340, after the earlier interaction shown on FIG. 6. During at least some portion of the interaction shown on FIG. 7, the mobile device 320 is placed in close physical proximity to the ATM 340, and NFC is established as a verification step in triggering the dispensing of cash.

At the top of the display screen 710, the digital banking systems app explains that an authentication step must be performed, to ensure the identity of the user. The app offers any one of three different types of authentication—including entering a personal identification number (PIN) on either the mobile device or the ATM screen, performing a facial recognition on the mobile device, or performing a biometric scan on the ATM. These are just examples used for illustrative purposes, and may vary from one implementation to another or even one ATM to another. For example, many ATMs currently do not have biometric scanning capability (e.g., fingerprint scan, retina scan, or facial recognition), but this may become more common in the future. The user identity authentication may be designed to take advantage of mobile device and ATM capability while ensuring a positive identification is made.

Following the user identity authentication, the user 310 is instructed to hold the mobile device 320 at a particular marked location on the ATM 340, where the mobile device 320 is within range of the ATM's NFC system. This is the point at which NFC is established between the mobile device 320 and the ATM 340, which serves as proof that the mobile device 320 is physically present at the ATM 340, and therefore the user 310 is ready and able to receive the cash which is dispensed. The NFC connection between the mobile device 320 and the ATM 340 also allows data to be sent and received between the units—such as client and account data. This information may have already been provided to the ATM 340 if the user pre-ordered the cash withdrawn in an earlier step; if not, it can be provided via the device-ATM NFC connection. The exchange of data via NFC is discussed further below with respect to another use case example.

To be clear—the authentication step at the top of FIG. 7 provides an extra layer of security by validating the identity of the user. The NFC connectivity step at the bottom of FIG. 7 validates the physical presence of the user and the mobile device at the ATM, to actually trigger the cash delivery, along with providing or confirming client/account identification.

The preceding discussion of FIGS. 6 and 7 describe one use case scenario for cardless cash withdrawal from an ATM using NFC. Other scenarios may be envisioned. For example—if the user 310 has prepared the cash withdrawal in advance using the digital banking app (as in FIG. 4)—then upon arrival at the ATM 340, the user 310 could first place the mobile device 320 at the designated location on the ATM 340 to establish NFC and verify that the user 310 is present at the machine. At that point, the user 310 could put away the mobile device 320, and only one other authentication step would be required—such as entering a PIN on the ATM screen, or a biometric scan (e.g., fingerprint, face or retina) performed by the ATM 340. Still other use case scenarios may be envisioned—all of them using an NFC channel between a mobile device and an ATM to verify the physical presence of the mobile device at the ATM, where the mobile device is running a digital banking systems app of the bank and the app is connected to an account having funds sufficient to cover the cash withdrawal. The exact sequence of steps, and the design of user interface screens, are matters of preference which may be determined as suitable for any particular implementation.

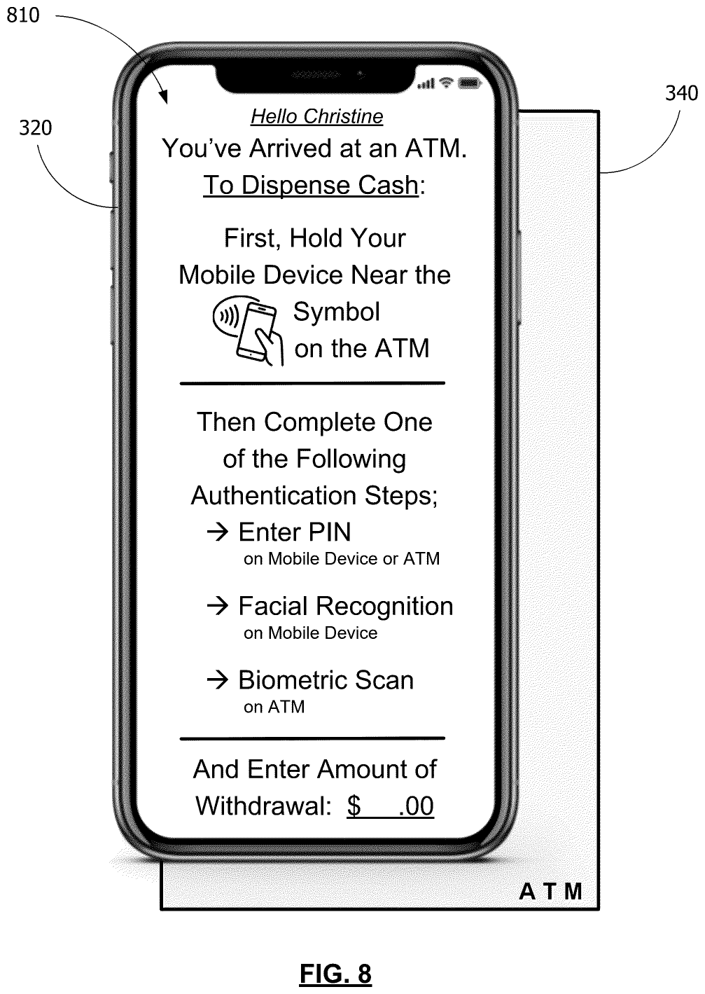

FIG. 8 is a mock-up illustration of a display screen 810 on the mobile device 320, depicting steps which may be taken by the user 310 in completing a cardless cash withdrawal from the ATM 340, according to another embodiment of the present disclosure. In FIG. 8, the mobile device 320 is again in the foreground with the ATM 340 in the background, indicating that the mobile device 320 and user 310 are at the location of the ATM 340. FIG. 8 depicts a scenario which may be the most simple and most preferred use case of the disclosed cardless cash withdrawal method. In FIG. 8, the user 310 simply walks or drives up to the ATM 340 and begins by placing the mobile device 320 at the designated location to establish NFC connectivity. That is, the act of placing the mobile device against the ATM truly replaces the traditional step of inserting an ATM card into the ATM to initiate the withdrawal.

At the top of the display screen 810, upon detecting that the mobile device 320 is located at an ATM (based on device location services and known ATM location data, as explained earlier), the digital banking systems app provides instructions to place the mobile device 320 near or upon the prescribed symbol on the ATM 340. This instruction is not actually necessary in many cases, as users learn that they can use their mobile device (running the digital banking systems app) instead of an ATM card. However, the instruction to the user is shown in FIG. 8 for the sake of completeness, as the app may be programmed to provide such instruction based on the user's location.

When the user 310 holds the mobile device 320 at the marked location on the ATM 340, the mobile device 320 is within range of the ATM's NFC system. NFC connectivity is then automatically established between the mobile device 320 and the ATM 340, which serves as proof that the mobile device 320 is physically present at the ATM 340, and the user 310 is ready and able to receive the cash which is dispensed. The NFC connection between the mobile device 320 and the ATM 340 also allows data to be sent and received between the units. For example, the ATM 340 may query for, and the mobile device 320 provide, the UserID of the user (client) in the digital banking systems app, which provides information about the bank client and the client's accounts, specifically the checking/debit account which is used for cash withdrawals. This information can then be used to ensure that sufficient funds are available in the designated account to cover the impending cash withdrawal. The client ID which is learned from the NFC data exchange may also be compared and confirmed in the following authentication step.

After the device-ATM NFC connectivity has been established and client/account identity has been provided as discussed above, an authentication step is performed to confirm the identity of the user. The app offers three different types of authentication; these are merely non-limiting examples, as discussed earlier with respect to FIG. 7. The authentication step provides an extra layer of security, as is desirable in financial transaction systems. For example, if someone finds or takes a person's mobile device and uses the mobile device at an ATM, a biometric authentication or a PIN entry is still required in order to withdraw cash, and an unauthorized user will not be able to accomplish this authentication step.

Finally, the user 310 is instructed to enter the amount of cash to be withdrawn. This numerical entry may be performed on the mobile device 320 or on the user interface screen or keypad of the ATM 340. The scenario of FIG. 8 may also occur after the user has pre-ordered a cash withdrawal as shown earlier in FIG. 4. If the cash withdrawal amount has already been defined, then the amount may simply be displayed at the bottom of FIG. 8 for confirmation, rather than requiring the user to enter the numerical value. Any and all such combinations of steps are envisioned in the techniques of the present disclosure. Upon entry/confirmation of the amount, the cash is dispensed.

FIGS. 6-8 depict the mobile device 320 adjacent the ATM 340. This is not meant to imply that the mobile device 320 must be in close physical proximity with (and having NFC connectivity with) the ATM 340 for the entire time that the user 310 is completing and authorizing the cash withdrawal. Rather, FIGS. 6-8 depict examples of user interaction with a mobile device which take place while the user is present at the ATM, but the mobile device may be outside NFC range from the ATM for some of this interaction. The placement of the mobile device 320 in close physical proximity to the ATM 340, for the establishment of NFC, is only necessary for a portion of this interaction, and may be only a brief moment to verify the user's physical presence and transfer a small amount of data.

In yet another design implementation, the ATM does not even need a user interface display screen or buttons, or a card slot. Instead, all user interaction takes place on the mobile device of the user, using the digital banking systems app running on the mobile device. During this interaction—which includes defining the amount and denomination mix of a cash withdrawal, PIN entry and/or biometric scan—the mobile device may be placed in continuous contact with the ATM for continuous NFC connectivity, or the mobile device may be placed in momentary contact with the ATM in order to verify the device's physical presence at the ATM and transfer client/account information. In this scenario, the ATM can be simplified considerably compared to current machine designs, where this simplification leads to increased reliability and lower cost of the ATM.

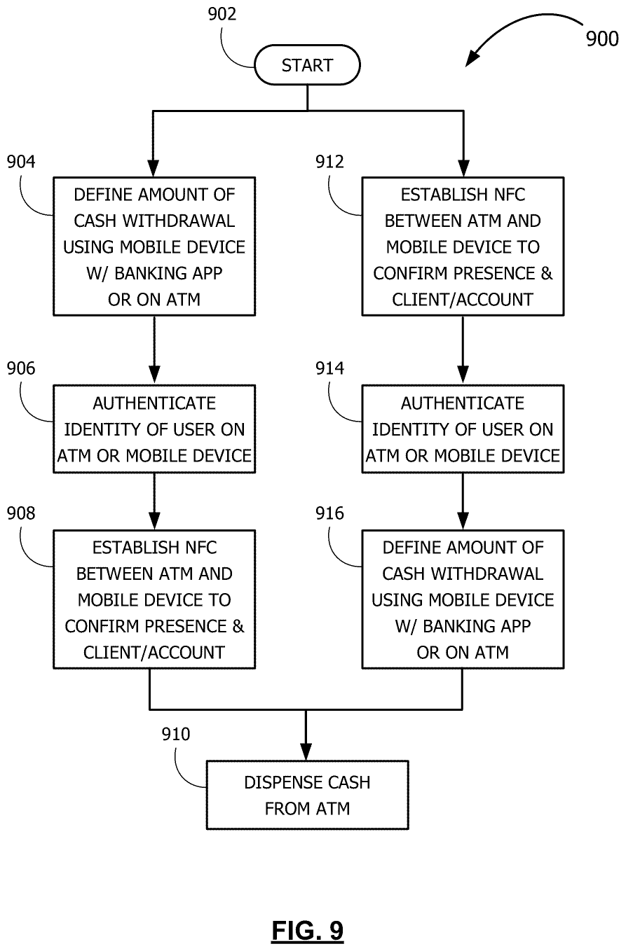

FIG. 9 is a flowchart diagram 900 of a method for making a cardless cash withdrawal from an ATM using a mobile device communicating via near-field communication (NFC), according to an embodiment of the present disclosure. The method of FIG. 9 begins at a start point 902 and from there takes one of two branches, depending on which of the previously-discussed scenarios is followed. The left branch of the flowchart 900 depicts the steps followed in the scenario of FIGS. 6-7, and the right branch depicts the steps followed in the scenario of FIG. 8.

At box 904, the user defines the amount of the cash withdrawal. This may be done on the mobile device (either in advance before arriving at the ATM, or when the user is present at the ATM), or it may be done on the user interface screen or keypad of the ATM itself. At box 906, the identity of the user is authenticated—either on the mobile device or on the ATM—such as by performing a biometric scan or by having the user enter a personal identification number (PIN). At box 908, the mobile device is brought into close physical proximity to a designated location on the ATM, and NFC connectivity is established. The NFC connectivity at the box 908 confirms that the device is physically present at the ATM and the user is able to receive the dispensed cash, and also enables data communication between the mobile device and the ATM—such as for client and account data.

To summarize—there are three possible means for data to be provided to the ATM; data from the digital banking systems app communicated via the cloud to the ATM, data entered directly into the ATM by the user, and data from the digital banking systems app (including data entered by the user) which is directly communicated to the ATM via NFC. After the box 908, the ATM knows the following via one or more of these means; the identity of the client and account for the cash withdrawal, the amount of the cash withdrawal (and denomination mix if desired), the user of the device is authenticated as the client, and the user is physically present at the ATM as witnessed by NFC connectivity to the mobile device. With all of this information, the ATM dispenses the cash at box 910.

In the right branch of the flowchart, following the scenario of FIG. 8, at box 912 the mobile device is brought into close physical proximity to a designated location on the ATM, and NFC connectivity is established. The NFC connectivity at the box 908 confirms that the device is physically present at the ATM and the user is able to receive the dispensed cash, and also enables data communication between the mobile device and the ATM—such as for client and account data. In this scenario, where the user places the mobile device on the ATM to start the process, it is more likely that all client and account data will be transferred via NFC from the mobile device to the ATM. The mobile device has the digital banking systems app installed and configured with client identification and account information. Once NFC connectivity is established between the mobile device and the ATM, other wireless communication connections may be used for data transfer—such as peer-to-peer WiFi or short-range Bluetooth.

At box 914, the identity of the user is authenticated—either on the mobile device or on the ATM—such as by performing a biometric scan or by having the user enter a personal identification number (PIN). At box 916, the user defines the amount of the cash withdrawal. This may be done on the mobile device or it may be done on the user interface screen or keypad of the ATM itself. After the box 916, from one or more of the communication channels discussed above, the ATM knows the client and account identity for the cash withdrawal, the user is physically present at the ATM, the user of the device is authenticated as the client, and the amount of the cash withdrawal (and denomination mix if desired). With all of this information, the ATM dispenses the cash at the box 910.

As outlined in the preceding discussion and shown in the figures, the NFC-enabled cardless ATM cash withdrawal technique of the present disclosure combines convenience and security to provide features not found in existing banking systems. The close physical proximity of the mobile device to the ATM not only ensures that the user is present to receive the dispensed cash, but also enables NFC connectivity which serves as a device-ATM communication channel. Combined with other features of the digital banking systems app, users have more options for making an ATM withdrawal, while also eliminating the need for the users to even carry an ATM card.

Particular embodiments and features of the disclosed methods and systems have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A method for device-machine interaction using short range communication technology, said method comprising:
bringing a mobile device into close physical proximity of less than five centimeters separation from a designated location on a machine;
establishing a near-field communication (NFC) connection between the mobile device and the machine;
transmitting data from the mobile device to the machine using the NFC connection;
validating an identity of a user of the mobile device; and
taking an action by the machine based on parameters including the data.

2. The method according to claim 1 wherein the mobile device and the machine each have a processor and memory, NFC capability, and internet communication capability to a remote computing device.

3. The method according to claim 1 wherein, after transmitting data from the mobile device to the machine using the NFC connection, ongoing communication between the mobile device and the machine is carried out using another, non-NFC, communication channel, where the other communication channel includes peer-to-peer WiFi or Bluetooth.

4. The method according to claim 1 wherein the machine is an automated teller machine (ATM), the mobile device runs a digital banking systems application (app), and the action is a cardless cash withdrawal from the ATM.

5. The method according to claim 4 wherein the cash withdrawal is only executed by the ATM when the user is physically present at the ATM as witnessed by the NFC connection to the mobile device.

6. The method according to claim 4 wherein the parameters include an amount of the cash withdrawal, a specification of a client account with sufficient funds to cover the amount of the cash withdrawal, and validation that the identity of the user of the mobile device corresponds with the client account.

7. The method according to claim 6 wherein the parameters further include a denomination mix of bills comprising the amount of the cash withdrawal.

8. The method according to claim 6 wherein the digital banking systems app includes features for the user to prepare for the cash withdrawal when the user is remote from the ATM, where the features include defining the amount of the cash withdrawal and providing directions to the ATM.

9. The method according to claim 6 wherein one or more of the parameters is entered directly into the ATM by the user, or is communicated to the ATM by the mobile device using a communication channel other than the NFC connectivity.

10. The method according to claim 4 wherein validating an identity of a user of the mobile device includes using a validation method selected from a group comprising; entering a personal identification number (PIN) into either the mobile device or the ATM by the user, performing a facial recognition of the user by the mobile device, and performing a biometric scan of the user by the ATM.

11. A method for cardless cash withdrawal from an automated teller machine (ATM), said method comprising:
bringing a mobile device into close physical proximity of less than five centimeters separation from a designated location on an ATM, where the mobile device runs a digital banking systems application, and the mobile device and the ATM are configured with near-field communication (NFC) capability;
establishing an NFC connection between the mobile device and the ATM;
transmitting data from the mobile device to the ATM using the NFC connection, where the data includes client and account data contained in the digital banking systems application;
validating an identity of a user of the mobile device, including using a validation method selected from a group comprising; entering a personal identification number (PIN) into either the mobile device or the ATM by the user, performing a facial recognition of the user by the mobile device, and performing a biometric scan of the user by the ATM;
verifying that all withdrawal parameters are defined, where the withdrawal parameters are contained in a group consisting of; an amount of the cash withdrawal, a specification of a client account with sufficient funds to cover the amount of the cash withdrawal, confirmation that the user of the mobile device is physically present at the ATM, and validation that the identity of the user of the mobile device corresponds with the client account; and
dispensing cash by the ATM based on the withdrawal parameters including the data transmitted from the mobile device to the ATM using the NFC connection.

12. The method according to claim 11 wherein one or more of the withdrawal parameters is entered directly into the ATM by the user or is communicated to the ATM by the mobile device using a communication channel other than the NFC connectivity, and where the digital banking systems application includes features for the user to prepare for the cash withdrawal when the user is remote from the ATM, where the features include defining the amount of the cash withdrawal and providing directions to the ATM.

13. A cardless cash withdrawal system enabled by near-field communication, said system comprising:
a mobile device including a processor, memory and near-field communication (NFC) capability, the mobile device running a digital banking systems application (app), where the mobile device is in communication with a remote computing device which interacts with the mobile device in running the digital banking systems application; and
an automated teller machine (ATM) including a processor, memory and NFC capability, where the ATM is also in communication with the remote computing device,
where the mobile device and the ATM are configured for performing steps including;
determining that the mobile device is in close physical proximity of less than five centimeters separation from a designated location on the ATM;
establishing a near-field communication (NFC) connection between the mobile device and the ATM;
transmitting data from the mobile device to the ATM using the NFC connection;
validating an identity of a user of the mobile device using either the mobile device or the ATM; and
dispensing cash by the ATM based on parameters including the data transmitted from the mobile device to the ATM using the NFC connection.

14. The system according to claim 13 wherein the remote computing device runs a banking back-office system which manages account transactions performed by the digital banking systems app and the ATM.

15. The system according to claim 13 wherein, after the NFC connection between the mobile device and the ATM is used to establish another, non-NFC, communication channel between the mobile device and the ATM, where the other communication channel includes peer-to-peer WiFi or Bluetooth.

16. The system according to claim 13 wherein dispensing cash is only performed by the ATM when the user is physically present at the ATM as witnessed by the NFC connection to the mobile device.

17. The system according to claim 13 wherein the parameters include an amount of a cash withdrawal, a specification of a client account with sufficient funds to cover the amount of the cash withdrawal, and validation that the identity of the user of the mobile device corresponds with the client account.

18. The system according to claim 17 wherein the digital banking systems app includes features for the user to prepare for the cash withdrawal when the user is remote from the ATM, where the features include defining the amount of the cash withdrawal and providing directions to the ATM.

19. The system according to claim 17 wherein one or more of the parameters is entered directly into the ATM by the user, or is communicated to the ATM by the mobile device using a communication channel other than the NFC connectivity.

20. The system according to claim 13 wherein validating an identity of a user of the mobile device includes using a validation method selected from a group comprising; entering a personal identification number (PIN) into either the mobile device or the ATM by the user, performing a facial recognition of the user by the mobile device, and performing a biometric scan of the user by the ATM.
